(19) United States
(12) Patent Application Publication
(10) Pub. No.: US 2022/0036622 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/008,154

(22) Filed: Aug. 31, 2020

(30) Foreign Application Priority Data
Jul. 29, 2020 (JP) 2020-128303

(51) Int. Cl. G06T 13/40

(52) U.S. Cl. CPC G06T 13/40

(57) ABSTRACT

To -enables you to take animations in a virtual space, an animation production system comprising: a virtual camera that shoots a character placed in a virtual space; a user input detection unit that detects an input of a user from at least one of a head mounted display and a controller which the user mounts; a character control unit that controls the action of the character in response to the input; an effect processing unit that adds an effect processing to the movie data captured by the camera in accordance with the color tone of an object disposed in the virtual space; and a display unit that outputs the movie data to which the effect processing is applied.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is an animation production system comprising: a virtual camera that shoots a character placed in a virtual space; a user input detection unit that detects an input of a user from at least one of a head mounted display and a controller which the user mounts; a character control unit that controls the action of the character in response to the input; an effect processing unit that adds an effect processing to the movie data captured by the camera in accordance with the color tone of an object disposed in the virtual space; and a display unit that outputs the movie data to which the effect processing is applied.

The other problems disclosed in the present application and the method for solving them are clarified in the sections and drawings of the embodiments of the invention.

### Advantageous Effects of Invention

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system 300 of the present embodiment.

FIG. 2 is a diagram illustrating an example of the overall configuration of an animation production system 300 according to an embodiment of the present invention.

FIG. 3 is a diagram schematically illustrating the appearance of the HMD 110 according to the present embodiment.

FIG. 4 is a diagram illustrating an example of a functional configuration of the HMD 110 according to the present embodiment;

FIG. 5 is a diagram schematically illustrating the appearance of the controller 210 according to the present embodiment.

FIG. 6 is a diagram illustrating an example of a functional configuration of a controller 210 according to the present embodiment;

FIG. 7 is a diagram illustrating a functional configuration of an image producing device 310 according to the present embodiment;

FIG. 8 is a diagram illustrating an example of a screen 7 displayed on a display device 311.

### DESCRIPTION OF EMBODIMENTS

The contents of embodiments of the present invention will be described with reference. The present invention includes, for example, the following configurations.

### [Item 1]

An animation production system comprising:

a virtual camera that shoots a character placed in a virtual space;

a user input detection unit that detects an input of a user from at least one of a head mounted display and a controller which the user mounts;

a character control unit that controls the action of the character in response to the input;

an effect processing unit that adds an effect processing to the movie data captured by the camera in accordance with the color tone of an object disposed in the virtual space; and

a display unit that outputs the movie data to which the effect processing is applied.

### [Item 2]

The animation production system according to claim 1, wherein

the effect processing unit performs the effect processing according to the color tone of the object disposed in the virtual space that enters the image angle of the camera.

### [Item 3]

The animation production system according to claim 1, wherein

the effect processing unit acquires the texture of the object and performs the effect processing according to the color of the pixel included in the acquired texture.

### [Item 4]

The animation production system according to claim 1, wherein

the effect processing unit sets a parameter in relation to the effect processing when the object is disposed in the virtual space.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### <Overview>

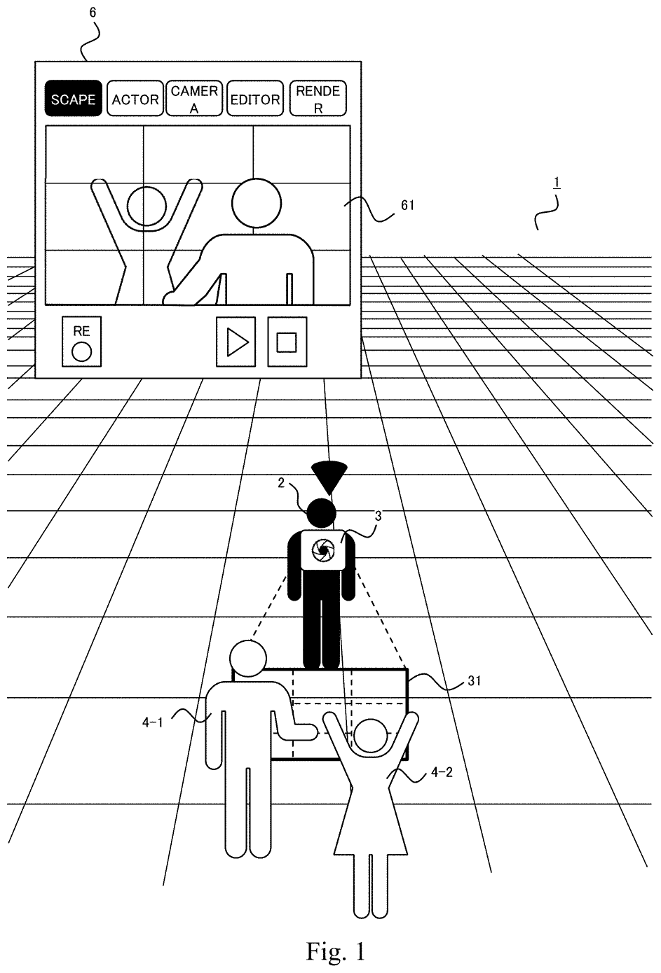

FIG. 1 is a diagram illustrating an example of a virtual space displayed on a head mount display (HMD) mounted by a user in an animation production system 300 according to the present embodiment. In the animation production system 300 of the present embodiment, a virtual character 4 and a virtual camera 3 are disposed in the virtual space 1, and a character 4 is shot using the camera 3. In the virtual space 1, a photographer 2 (a photographer character) is disposed, and the camera 3 is virtually operated by the photographer 2. In the animation production system 300 of this embodiment, as shown in FIG. 1, the user arranges the character 4 and the camera 3 while viewing the virtual space 1 from a bird's eye (Third Person's View), shoots the character 4 using the FPV (First Person View) as the photographer 2, and performs the performance of the character 4 using the FPV, while producing the animation. In the virtual space 1, a plurality of characters 4 (in the example of FIG. 1, characters 4-1 and 4-2) can be disposed, and the user can perform the performance while possessing a character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 2 can be virtually operated as the photographer 2, natural camera work can be realized and the representation of the movie to be shot can be enriched.

### <General Configuration>

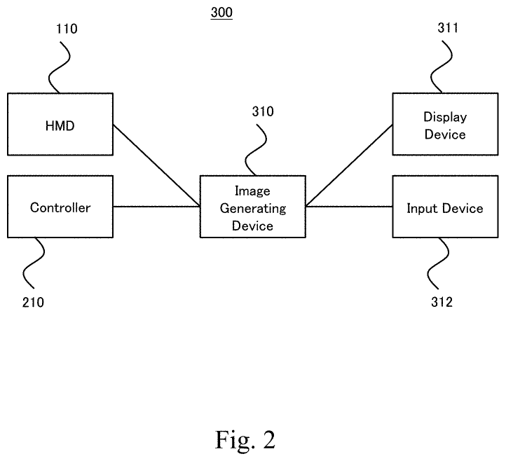

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. The image generating device 310 may include a display device 311, such as a display, and an input device 312, such as a keyboard, mouse, or touch panel. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

### <HMD110>

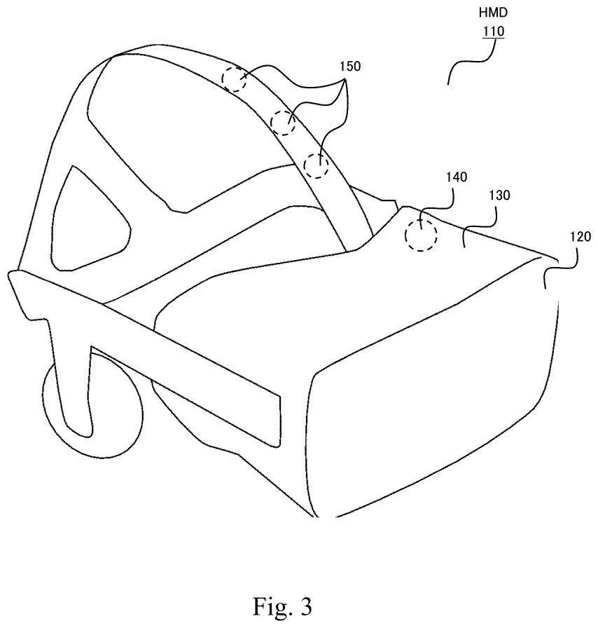

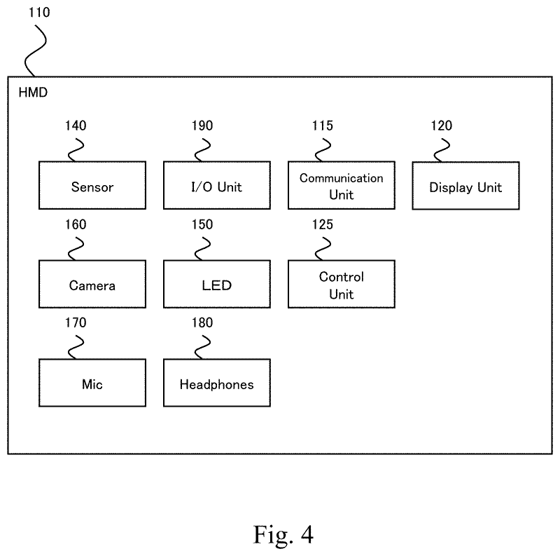

FIG. 3 is a diagram schematically illustrating the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although the display panel 120 may be an optically transmissive or non-transmissive display, the present embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### <Controller 210>

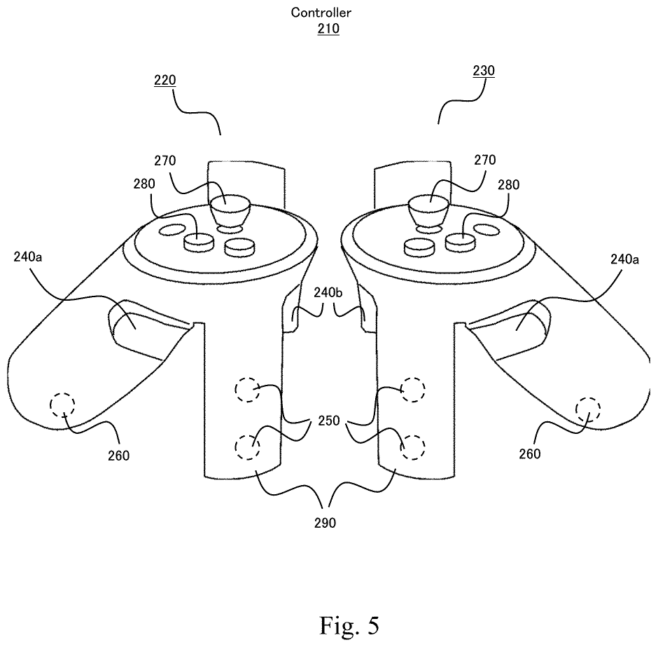

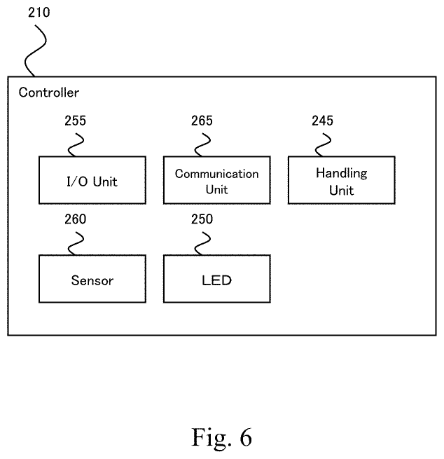

FIG. 5 is a diagram schematically illustrating the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

### <Image Generator 310>

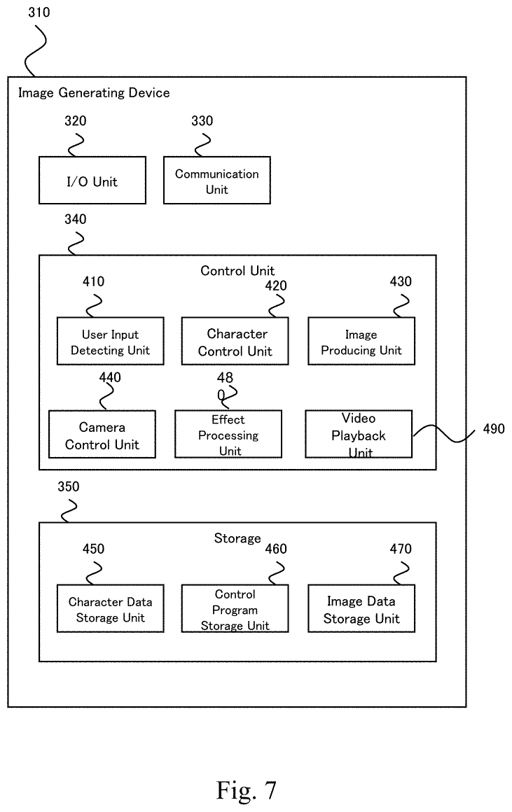

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110, the controller 210, and/or the input device 311 regarding the movement of the user's head or the movement or operation of the controller 210 is detected in the control unit 340 as input content including the operation of the user's position, line of sight, attitude, speech, operation, etc., and a control program stored in the storage unit 350 is executed in accordance with the user's input content to perform a process such as controlling the character 4 and generating an image. The user input detecting unit 410 may also receive input from an input device 312, such as a keyboard or a mouse. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the movement of the user's head and the movement or operation of the controller, a character control unit 420 that executes a control program stored in the control program storage unit 460 for a character 4 stored in the character data storage unit 450 of the storage unit 350, a camera control unit 440 that controls the virtual camera 3 disposed in the virtual space 1 according to the character control, and an image producing unit 430 that generates an image in which the camera 3 captures the virtual space 1 based on the character control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4. The image producing unit 430 registers the action data representing the movement of the character 4 controlled by the character control unit 420 and the movement (operation) of the camera 3 controlled by the camera control unit 440 in the image data storage unit 470, and generates an image in which the movement of the character 4 is virtually captured by the camera 3. The image producing unit 430 is displayed on the display unit 61 of the control panel 6 disposed in the virtual space 1 and can also be displayed on the display device 311. Further, the image producing unit 430 may display the generated image on a display portion (not shown) provided by the camera 3.

The storage unit 350 stores in the aforementioned character data storage unit 450 information related to the character 4, such as the attribute of the character 4, as well as the image data of the character 4. The control program storage unit 460 controls the operation and expression of the character 4 in the virtual space and stores a program for controlling an object such as the camera 3. The image data storage unit 470 stores the image generated by the image producing unit 430. In this embodiment, the image stored in the image data storage unit 470 can be an action data for generating a moving image. The action data may include, for example, 3D data for displaying the character 4 in the virtual space 1, pause data for identifying the bone structure of the 3D data, motion data for identifying the movement of the bone structure, and the like. Further, the image producing unit 430 may create (render) a dynamic image based on the action data and register the dynamic image data as a result of rendering in the image data storage unit 470.

### <Movie Post Effect>

The control unit 340 also includes an effect processing unit 480 for applying an effect to the movie. The effect processing unit 480 adds an effect to the pixel of the movie (two-dimensional moving image) generated by the image producing unit 430, rather than a simulation process in which the rendering is performed considering the light source, etc. in the virtual space 1. Effects can employ processing that is applicable to any two-dimensional dynamic image. Effects may include, for example, Bloom effects, Depth of Field effects, Bigneting effects, Color Grading effects, Color Curve effects, diffusion filters, and the like, and the like. Parameters are set for the effect. Parameters may be entered, for example, from an input device 312, such as a keyboard or mouse.

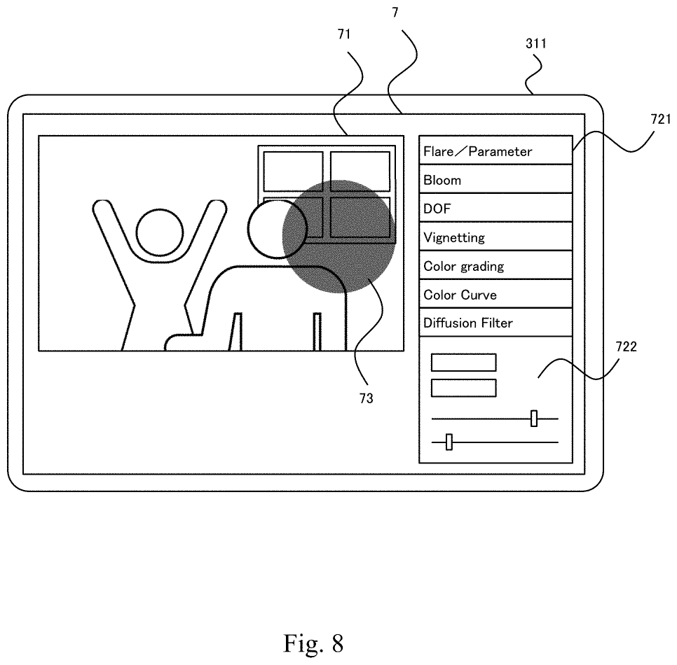

FIG. 8 is a diagram illustrating an example of a screen 7 displayed on a display device 311. In the screen 7, a selection unit 721 for selecting the type of the effect applied by the effect processing unit 480 and a setting unit 722 for setting the parameter of the effect are provided. Further, in the display unit 71, an image in which an effect by the effect processing unit 480 is added to the movie generated by the image producing unit 430 is displayed. In the example of FIG. 8, in the selecting unit 721, a flare effect is selected, and a parameter such as the size and color of the flare is shown set in the setting unit 722. The flare 73 may also be positioned by an input device 312, such as a mouse, for example by a user. In the display unit 71, a flare 73 is superimposed on the image. In addition, the selection of an effect or the input of a parameter may be performed in the virtual space 1. For example, the control panel 6 may provide a selection unit 721 for an effect or a setting unit 722 for a parameter.

In this manner, the appearance of light being inserted through the window can be represented by a flare 73. In the same way, effects other than flare can be applied.

The effect parameters may be automatically adjusted. For example, the effect processing unit 480 can perform an effect processing according to the color tone of the object disposed in the virtual space 1. Among the objects disposed in the virtual space 1, effect processing can be performed according to the color tone of the object shown in camera 3, especially the active (taking the final movie image). The color tone of the object can be the color tone of the pixel included in the texture attached to the object. The effect processing unit 480 may, for example, perform a color correction for correcting the saturation so that the color tone of each frame in the image of one cut shot by the camera 3 is in a predetermined range, and all the color tones of the image of the plurality of cuts are within a predetermined range.

The effect processing unit 480 may change the color parameters of the circular image which are superimposed as flares, for example, according to the color tone of the object. Again, the effect processing unit 480 can correct the parameters relating to the color of the flare so that the color tone of the image after the effect processing is within a predetermined range. For effects processing other than flare, similar processing can be performed for those related to color. The effect processing unit 480 can correct the color tone of the flare in accordance with the color tone of the object (of the texture) included in the applied range of the flare (in the circle representing the flare 73 of FIG. 8). Similarly, for effect processing other than flare, parameters relating to the color of the effect may be corrected depending on the tone within the range to which the effect processing is applied, for example, such that the tone of the image after the effect processing is within a predetermined range.

The effect processing unit 480 may perform correction according to the hue. The effect processing unit 480 can correct the parameters relating to the color of the effect so that the hue after the effect processing is within a predetermined range.

As described above, according to the animation production system 300 of the present exemplary embodiment, a user can operate the camera 3 as the camera man 2 in the virtual space 1 to take video images. Accordingly, since the camera 3 can be operated in the same way as in the real world to take photographs, it is possible to realize a natural camera work and to provide a richer representation of the animated video.

Further, according to the animation production system 300 of the present embodiment, an image resulting from an effect processing can be displayed on a display unit 61 in a display device 311 and/or a virtual space 1 for an image generated by the image producing unit 430. This allows the user to create an animation while viewing the final results applied to the effect.

In the animation production system 300 of the present embodiment, the display device 311 and the input device 312 disposed outside the virtual space can be used to select the type of effect to be processed by the effect processing unit 480 and to accept the input of the parameters of the effect. Therefore, the author who operates the character 4 or camera 3 and the author who adjusts the effect can work independently. In other words, animation production can be performed by separating the producers responsible for performance and camera work from the producers responsible for the final quality adjustment of the video.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

In the present embodiment, the grid 31 is divided into three sections, vertically and horizontally, but a dividing line 32 that is divided in any number can be displayed.

In the present embodiment, the user possessed by the camera man 2 or the character 4 performs an operation to adjust the position of the grid 31. However, the position of the grid 31 may be adjusted in a state where the virtual space 1 is overviewed (the user is not possessed by the camera man 2 or the character 4). In this case, the user can grasp and move the grid 31.

### EXPLANATION OF SYMBOLS

1 virtual space

2 cameraman

3 cameras

4 characters

6 control panel

7 Screens

31 Grid

32 split line

61 display

71 display

72 playback button

110 HMD

120 display panel

130 housing

140 sensor

150 light source

210 controller

220 left hand controller

230 right hand controller

235 grip

240 trigger button

250 Infrared LED

260 sensor

270 joystick

280 menu button

300 Animation Production System

310 Image Generator

311 display

312 input device

320 I/O portion

330 communication section

340 controller

350 storage

410 User Input Detector

420 character control unit

430 Image Generator

440 Camera Control

450 character data storage section

460 Program Storage

470 Image Data Storage

490 Movie Playback

1. An animation production system comprising:
a virtual camera that shoots a character placed in a virtual space;
a user input detection unit that detects an input of a user from at least one of a head mounted display and a controller which the user mounts;
a character control unit that controls an action of the character in response to the input;
an effect processing unit that adds an effect processing to movie data captured by the virtual camera in accordance with color tone of an object to be shot by the virtual camera, the object disposed in the virtual space; and
a display unit that outputs the movie data to which the effect processing is applied,
wherein the effect processing unit acquires a texture of the object to be shot and performs the effect processing according to a color of a pixel included in the acquired texture.

2. The animation production system according to claim 1, wherein
the effect processing unit performs the effect processing according to the color tone of the object disposed in the virtual space that enters the image angle of the camera.

3. (canceled)

4. The animation production system according to claim 1, wherein
the effect processing unit sets a parameter in relation to the effect processing when the object is disposed in the virtual space.
